(19) United States
(12) Patent Application Publication
(10) Pub. No.: US 2010/0075126 A1
(43) Pub. Date: Mar. 25, 2010

(54) METHODS AND APPARATUS FOR MAKING THERMOPLASTIC PREPREG WITH SPECIFIC FIBRE ORIENTATION

(75) Inventors: Roger Anthony Ford, Suffolk (GB); Richard Curtis, Colchester Essex (GB)

Correspondence Address: KNOBBE MARTENS OLSON & BEAR LLP, 2040 MAIN STREET, FOURTEENTH FLOOR, IRVINE, CA, 92614, US

(73) Assignees: Integrated Materials Technology Limited, Bury St. Edmunds Suffolk (GB); Pultrex Limited, Colchester Essex (GB)

(21) Appl. No.: 12/594,571

(22) PCT Filed: Apr. 2, 2008
(86) PCT No.: PCT/GB2008/050236

§ 371 Date: Nov. 12, 2009

(30) Foreign Application Priority Data
Apr. 2, 2007 (GB) 0706430.6

(51) Int. Cl. B29C 70/32; B29C 70/54; B29C 53/58; B29K 101/12

(52) U.S. Cl. 428/222; 156/426; 156/193

(57) ABSTRACT

An apparatus for producing single ply, continuous, cross ply or angle ply thermoplastic prepregs comprising means for feeding a tape of thermoplastic prepreg material into the apparatus and around at least one carrier means for positioning and aligning the tape to form a tube in such a way as to maintain substantially uninterrupted contact between the leading edge of the incoming tape of material and the receding edge of the previous wrap of the tape means for creating a cohesive transitional tube by joining the edges of adjacent wraps means for cutting the resulting cohesive transitional tube so as to produce at least one thermoplastic prepreg product with desired shape, size and ply fibre orientation and means for collecting the thermoplastic prepreg products so produced.

### FIELD OF THE INVENTION

This invention relates to the manufacture of composite laminated structures. In particular, the invention includes the formation of thermoplastic prepreg sheet materials.

### REVIEW OF ART KNOWN TO THE APPLICANT

It is common practice in the production of laminated composite parts to cut the necessary component plies from unidirectional (“UD”), prepreg material, which is available in continuous form. The prepreg is oriented and cut to create the shaped plies, which are then stacked in the correct orientation sequence. The resulting pack of ply material is then consolidated by heat and pressure, in appropriate equipment, to form the required part.

There are drawbacks to this procedure. It is slow, it is labour intensive and it can generate a considerable amount of prepreg waste. This is particularly the case where, for example, the UD material is only available at an inconvenient width, or some of the required plies involve off-axis fibre orientation. Such problems lead to fabrication processes which can be very expensive.

In an attempted solution to these problems continuous cross or angle ply thermoset prepregs have previously been made in small quantities by the manual or robotic cutting and laying-up of UD material. However, it proved necessary to produce them in a two ply, biaxial form because of handling problems arising from the instability of these non-rigid, chemically meta-stable, [b-staged], materials. By making use of the inherent tack of the material to combine the plies, a two ply product of adequate stability could be produced.

Nonetheless, stability problems together with difficulties in achieving significant reductions in fabrication costs, led to the products subsequently being withdrawn from the market.

Thermoplastic prepregs do not suffer from the problems associated with the meta-stable state of thermoset prepregs. Their polymerisation has been completed before impregnation, with the result that they are rigid, non-tacky and inherently stable materials with a long shelf life. Moreover, since they can be heated, if necessary many times over without causing chemical degradation, they are suitable for conversion into post-formable semi-finished stock materials, an economically valuable option not open to thermoset materials. Continuous, 0/90°, two ply thermoplastic materials have been produced in small quantities by manual or robotic cutting and lay-up, where the plies have been combined by thermal fusion, but single ply, cross or angle ply prepregs, which offer greater flexibility in laminate design and are easier to handle, because of their single ply form, are not as yet commercially available.

The applicant is aware of the following specifications: WO00/18563, WO 99/20457, JP 2640257, GB 1256287 and EP 0494729. Whilst these relate to the production of composites, none of them relates to the processing of UD, single ply, cross or angle ply thermoplastic prepreg material, much less the presentation of either a continuous tape of this material, or the cutting of it into sheets.

It is an object of the present invention to provide methods and apparatus for the continuous production of UD, single ply cross or angle ply thermoplastic prepregs, which avoid the problems and high processing costs associated with the existing manual and robotic methods used to lay up such materials.

A further object of the present invention is to provide the consumer with a supply of continuous UD, single ply, cross or angle ply thermoplastic prepregs in the specific widths or sheet sizes required by the consumer, thereby offering significant savings of time and prepreg usage during the material preparation stage. This should yield major reductions in processing cost not only for the manufacturer of shaped composite parts but also for the producer of multi-ply composite sheets and the parts made there-from.

### SUMMARY OF THE INVENTION

In its broadest aspect, the invention provides an apparatus for continuously producing UD, single ply, cross or angle ply thermoplastic prepregs comprising means for feeding a tape of thermoplastic prepreg material into the apparatus and around at least one carrier, means for positioning and aligning the tape to form a tube in such a way as to maintain substantially uninterrupted contact between the leading edge of the incoming tape of material and the receding edge of the previous wrap of the tape, means for creating a cohesive transitional tube by joining the edges of adjacent wraps, means for cutting the resulting cohesive transitional tube so as to produce at least one thermoplastic prepreg product with desired shape, size and ply fibre orientation and means for collecting the thermoplastic prepreg products so produced.

This configuration is advantageous in that it enables the user to produce single ply prepreg tapes, sheets and tabular materials by a continuous process, products for which there is a marked demand.

The continuous nature of the process is particularly advantageous because it facilitates the production of a product with a consistency of character and quality. Such a continuous process further serves to keep the cost of production down.

In a subsidiary aspect of the invention the tape is fed around successive carriers capable of relative movement towards and/or away from one another.

This configuration is advantageous in that it enables products with a wide range of dimensions and/or fibre orientations to be made with minimal waste.

Moreover, this configuration is further advantageous in that, in use, it is easy to adjust the equipment to produce different specifications of product. In one embodiment, such adjustments might comprise means for setting the periphery of the required cohesive transitional tube, the helix angle for wrapping the incoming tape and the helix angle for cutting the cohesive transitional tube.

Such adjustability allows for flexible manufacturing, which is particularly advantageous for the fabricator of composite parts, but will be advantageous to any operator who requires efficiency and cost effectiveness in production.

A still further advantage of this configuration, which uses successive carriers is that it allows the joining of the incoming tape to be effected along and within a planar section of the periphery of the supported transitional tube. This is of particular value in enabling the production of flat products in the case where thermal fusion followed by rapid cooling is used to create the cohesive transitional tube.

In a subsidiary aspect of the invention at least one carrier is slatted.

The slatted construction of the carriers is of particular advantage in that it facilitates reduced friction or frictionless contact with the tube. This is of particular importance if the strip being joined is being distorted in such a way that the resultant tube tends to reduce in diameter and so grips the carriers. Such distortion may have the effect of upsetting the positional control of the incoming tape, which leads to inferior control of the joining process.

In a subsidiary aspect of the invention at least one carrier is provided with rotational and axial degrees of freedom of movement.

The provision of such freedom of movement, which might be effected by the use of bearings or similar, is particularly advantageous in that the provision of such bearings provides means to precisely adjust the carriers to the vector of the incoming material. Alternatively, the carrier or carriers may be self-adjusting.

The provision of such means is further advantageous in that the cutting path may therefore be controlled in any direction in relation to the tube surface, to produce shaped sheets or irregular strip as well as continuous off axis tape.

In a subsidiary aspect of the invention the joining of the edges of the adjacent wraps of the cohesive transitional tube is effected within a planar section of the periphery of the tube.

In a subsidiary aspect of the invention, upon actuation, the means for cutting the material moves with multiple degrees of freedom to define a path to cut the tape into sections and profiles of the desired shape, size and fibre orientation.

This provision of such means is particularly advantageous in that it enables sheets to be cut out of the composite material during production, of prescribed specification with regard to width, length and fibre orientation.

The provision of such means is further advantageous in that it may be utilised to provide lengths of single continuous tubular composite material of prescribed specification with regard to tube diameter and the helical angle of its fibre reinforcement which may later be cut in to finished products, such as tapes and sheets.

In a subsidiary aspect of the invention, upon actuation, the means for cutting the cohesive tube follows an helical path to produce one or more continuous, single ply, cross or angle ply composite prepregs with the desired fibre orientation. The product may also be of a prescribed width and may later be used in the production of continuous multi-ply laminate sheets.

In a subsidiary aspect of the invention the manner of cutting the resulting cohesive transitional tube is slitting.

The invention also comprises a method for continuously producing UD single ply, cross or angle ply thermoplastic prepreg, comprising the forming of a tape of thermoplastic prepreg into a tube, by wrapping it round a system comprised of at least one carrier, the positioning and aligning of the tape to form a tube in such a way as to maintain substantially uninterrupted contact between the leading edge of the incoming tape of material and the receding edge of the previous wrap of the tape, the creating of a cohesive transitional tube by joining the edges of adjacent wraps, the cutting of the resulting tube, to produce the required thermoplastic prepreg product, and the collecting of the prepreg products so produced.

The invention also comprises UD, single ply, thermoplastic prepreg materials in initially continuous form, whenever made by an apparatus or method as described above.

The invention also comprises apparatus for the conversion of thermoplastic material into initially continuous composites substantially as described herein with reference to and illustrated in any appropriate selection or combination of the description and the drawings.

### BRIEF DESCRIPTION OF THE DRAWINGS

The invention is illustrated but not limited by the following description with reference to the accompanying drawings, which are not to scale and of which;

FIG. 1 shows the apparatus in perspective view from one side.

FIG. 2 shows the apparatus in a further perspective view from the other side.

FIG. 3 shows the apparatus side on.

FIG. 4 shows the apparatus end on.

FIG. 5 shows the apparatus in a further perspective view.

FIG. 6 shows the apparatus in a further perspective view.

FIG. 7 shows the path of the tape in a perspective view.

FIGS. 8, 9, 10, 11 and 12 illustrate further aspects of the process.

FIG. 12 is an elevation view of the sheet forming process.

### DETAILED DESCRIPTION OF THE DRAWINGS

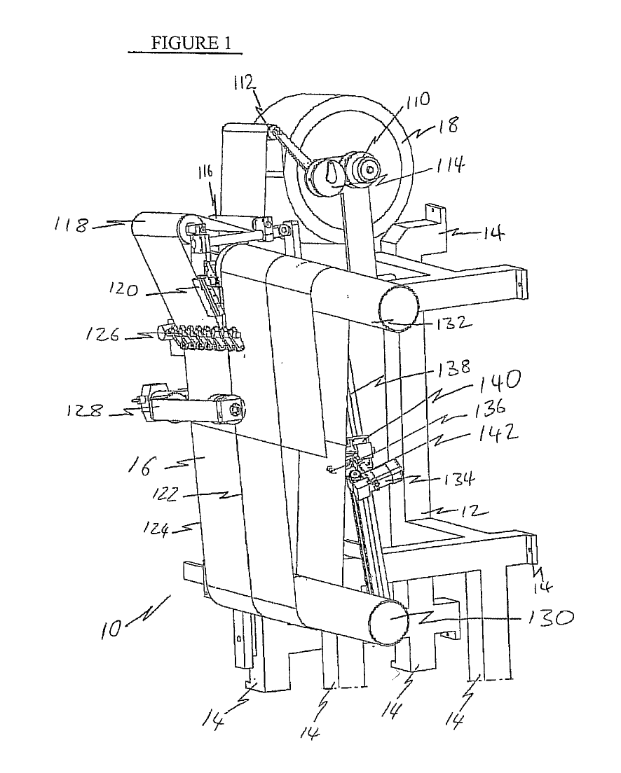

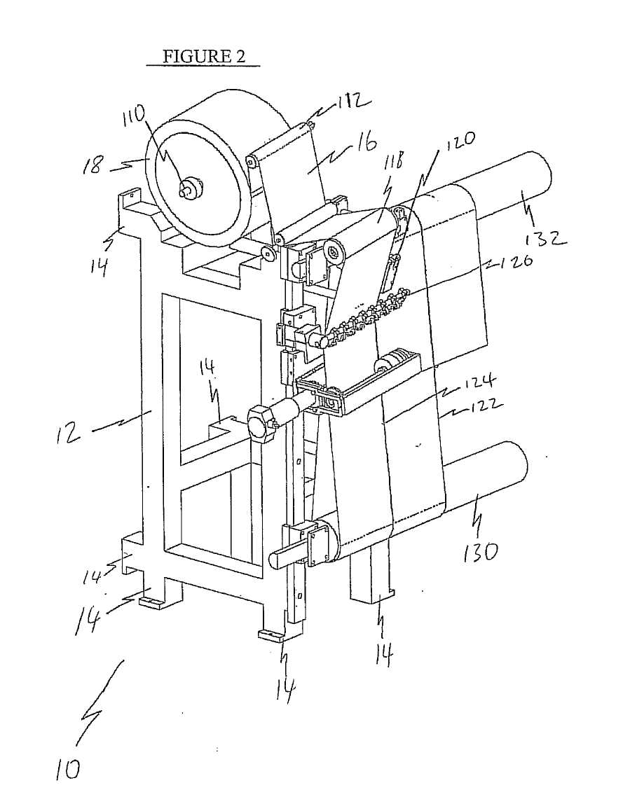

FIG. 1 shows the apparatus in perspective view. It is indicated generally at 10. The apparatus 10 comprises a frame 12. The frame 12 has a multiplicity of feet 14 which may be attached using means known to the skilled man to the surface of a working environment. The position of the feet 14 advantageously allows the apparatus 10 to be mounted in such a way that the path of the tape 16 is either substantially vertical or substantially horizontal, although other angular configurations may also be envisaged. The orientation of the apparatus may be determined by the type of feedstock infeed, which for example may be a coil or a direct connection with a UD tape manufacturing process, the method of collection, which may for example be a strip coiler, a sheet collator, an offload conveyor or a robot pick-and-place device, and ergonomic considerations.

On the frame 12 is a roll 18 of tape 16 which has a leading edge 122 and a receding edge 124. This is on a carrier 110 which in this embodiment is a chuck on a mandrel having a controlled torque brake which controls tension in conjunction with the dancing roller (carrier 112). In use, the roll 18 of tape 16 is unwound by the apparatus 10 in such a way that the tape 16 is guided through the apparatus 10 and the desired end product is produced. Any appropriate actuation means known to the man skilled in the art may be used to this end. In this embodiment, the tape passes over carrier 112 which in this embodiment features angle adjustment and locking means, which may be advantageously utilised to facilitate the loading of the tape 16 and in use to adjust the tension of the tape 16.

The tape 16 then interacts with further carriers 116, 118. These carriers both feature alignment means (not shown) which may be used to finely adjust the flow of the tape 16. The carriers 116, 118 feed the tape 16 through heating means 120 which serves to heat the leading edge 122 of the tape 16 to a temperature which will allow it to be bonded to the receding edge of an adjacent wrap of the tape 16. This edge is similarly heated by a secondary heating means (not shown). Advantageously, the carriers 116, 118 have or are fitted with bearings allowing them rotational and axial degrees of freedom of movement.

In this embodiment, the heating means 120 is a metal plate, but the skilled man may advantageously utilise laser, infra-red or ultrasonic technology or any other means available to perform the same task. Alternatively, chemical reagents such as adhesives are also envisaged as means for preparing the tape 16 for bonding.

The tape 16 is subsequently fed through guide device 126 which in this embodiment comprises an arrangement of small rollers, but may advantageously consist of a single guide roller. The significance of the guide device is that it serves to introduce the leading edge 122 of a wrap of tape 16 to the receding edge of a preceding wrap of tape 16. The tape 16 then passes through a frame supporting a drive motor which advances the tape, a pair of spindles carrying both consolidation rollers and rubber coated drive rollers, and a clamp to bring the spindles into driving contact 128. This feature forces the two aforementioned edges of the tape together to the extent that a bond may be thus formed.

In preferred embodiments the spacing between heating means 120 and the consolidation rollers is of a distance which best allows the introduction and bonding to take place between the wraps of tape 16. In certain embodiments, cooling means (not shown here) may be fitted to the apparatus 10 to ensure the bond between leading edge 122 and receding edge 124 of the tape 16 is appropriately set.

The apparatus 10 further comprises a first mandrel 130 and a second mandrel 132, both of which are adjustable as to relative disposition. One or more of the mandrels 130 132 may be tapered, slatted, in particular longitudinally, or otherwise formed so as to promote the path of the tape 16 which in the illustrated embodiment is shown to be helical. This allows the tape 16 to be angled in such a way as to present the cutter 134 with a tape 16 surface through upon which it may work to produce a product with the desired cross or angled ply products. In some embodiments the motion of the mandrels 130, 132 will be fully programmable, allowing in particular for their continuous or velocity profiled rotation. A particularly advantageous combination of features allowing for freedom of movement would be the provision of longitudinal slats mounted on linear bearings in conjunction with intermediate supports which would in turn be mounted on journal bearings.

The apparatus further comprises a cutter 134. In this embodiment it comprises a driven disc in contact with a retractable blade 136. In another embodiment it may be a stand-alone blade, a laser, a saw, a jet or other means. The cutter 134 may be static or dynamic, and may be fully or partially programmable or otherwise adjustable to follow a desired path and thus to cut products of the desired dimensions and grain directions from the tape 16. In the embodiment shown, the cutter 134 further comprises a slider which may be inclined at an angle apposite for the production of a desired product. Means are provided 140 for moving the blade up and down the slide 138 at a velocity interpolated to the material speed to provide a determinable helical cutting angle. Further means 142 are provided for moving the cutter into and out of engagement with the material, which in this embodiment are pneumatic in nature but may equally be hydraulic or of any other type familiar to the man skilled in the art. The finite cuts thus produced are repeated programmably to produce one or more continuous helical slits. In one embodiment movement means 140 142 may be provided by a robot capable of programmable continuous path motion such as a Cartesian robot. Such means allow for the flexible positioning of the cutter 134, facilitating its cutting the tube in a programmable path relative to the surface of the tube and the fibre axis.

In particularly preferred embodiments, the cutter 134 will, upon actuation, create a bi-directional cut in the cohesive transitional tube such that one axis follows an off-axis path defining the fibre orientation of the product, whilst the second connects the start and finish of the first cut, so creating a complete peripheral cut and enabling the separations of a required quantity of material from the advancing cohesive transitional tube.

The provision of such a cutter 134 is advantageous because subsequent opening out of the separated material, by continuation of the second cut, enables sheets of prescribed specification, with regard to width, length and fibre orientation, to be produced so that waste during subsequent steps in the fabrication process can be minimised.

In a further embodiment the cutter may be mounted in the collection device such as a coil reeler. In this case cutting could be continuous and mechanically set.

In a further embodiment, the cutter 134 may be supplemented with or substituted by a marker.

Having been cut in the required manner, the tape 16 will be fed using means known to the man skilled in the art (not shown), to a site where it may be further packaged or prepared using further means known to the man skilled in the art (not shown). Such means may be a drum, a reel system rotating in a planetary fashion, a sheet collator or a pick-and-place device of a known variety.

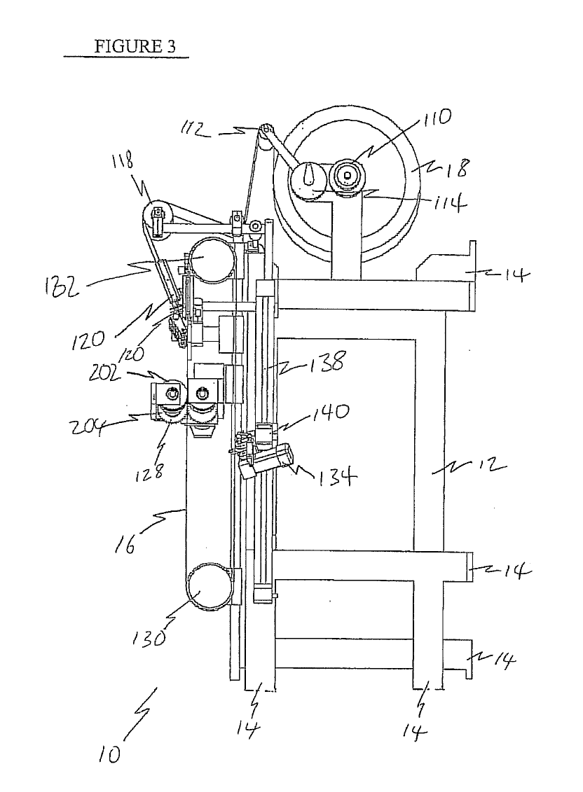

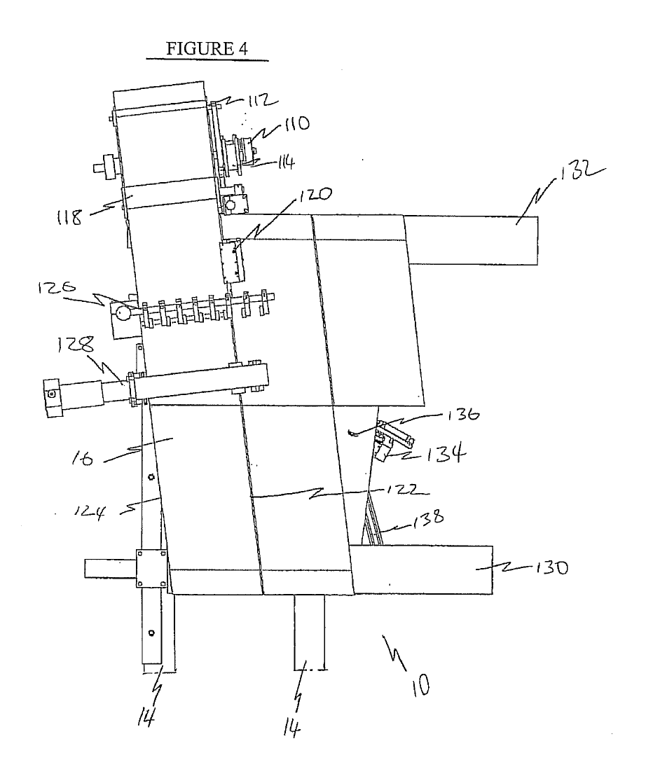

FIG. 3 is or particular interest because the heating means 120 are shown to comprise two metal plates, one on either side of the tape 16. The metal plates are preferably infrared heaters. The consolidation rollers are also shown to be on either side of the tape 16, also shown are gears 204 for synchronising the rotation of the rollers. Means of consolidation alternative to rollers, such as plates, are envisaged. Further means known to the man skilled in the art are also envisaged.

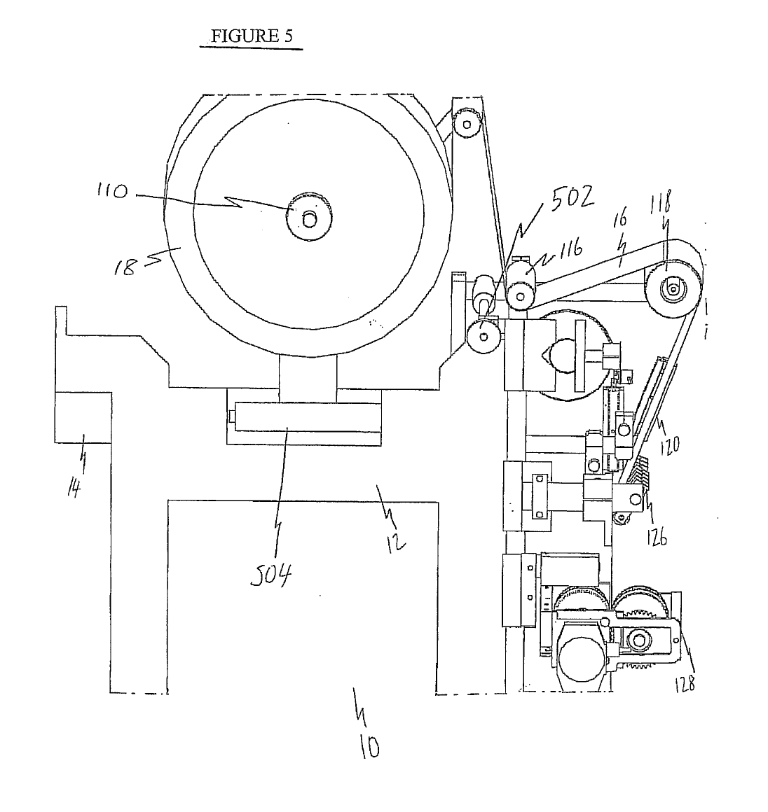

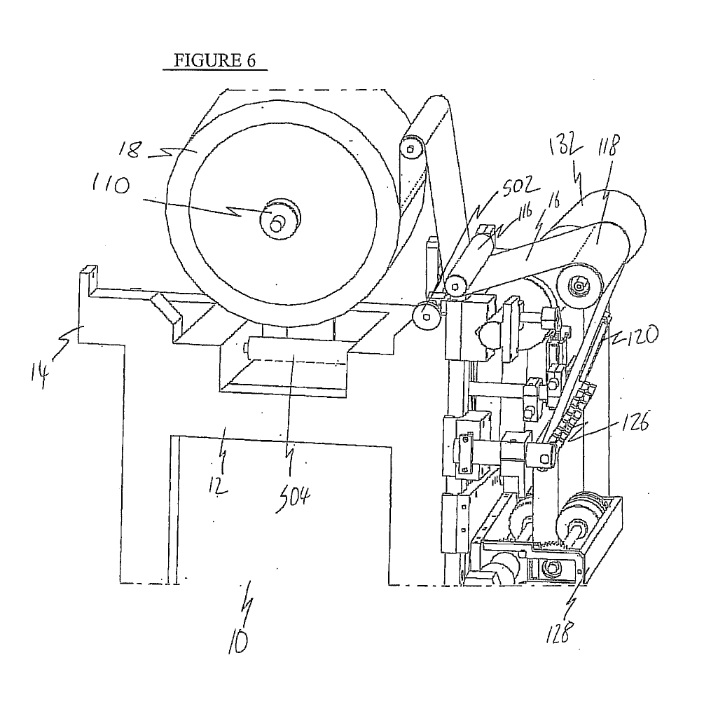

FIG. 5 is also of further note because it illustrates the presence of manual adjustment means 502, relating to carrier 112. Adjustment means for the other carriers is envisaged. Preferred embodiments will have control means allowing infeed guidance and heaters to all be adjusted together to simplify resetting. In particular, unified control means of the sub-assembly 110, 112, 114, 116, 118, 120 and 150 is envisaged. Overall control means 504 is also shown.

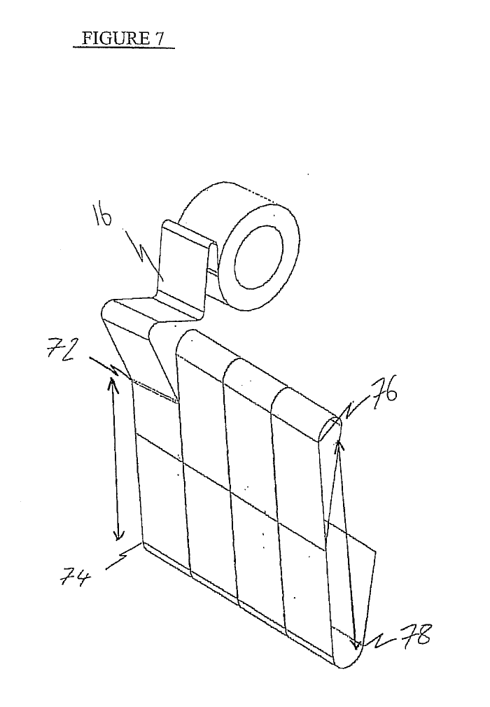

FIG. 7 is also of note because it shows the path of the tape 16 through apparatus 10 (not shown). Such a view serves to emphasise the large planar sections of tape 16, that comprise the supported tube. 72, 74, 76, 78

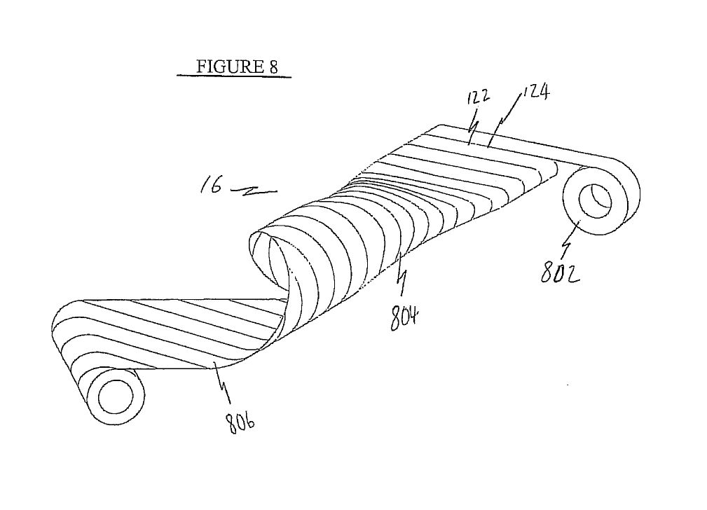

FIG. 8 illustrates single strip infeed, single strip converted output using 2 mandrels. (not shown) The changes in the state of the tape 16 are clearly shown. Clearly shown are the tape 16 in its infeed state 802, the point at which leading edge 122 and receding edge 124 are joined to form transitory cohesive tube 804 which may be cut into an end product—here the outfeed 806 comprises a continuous angle ply tape.

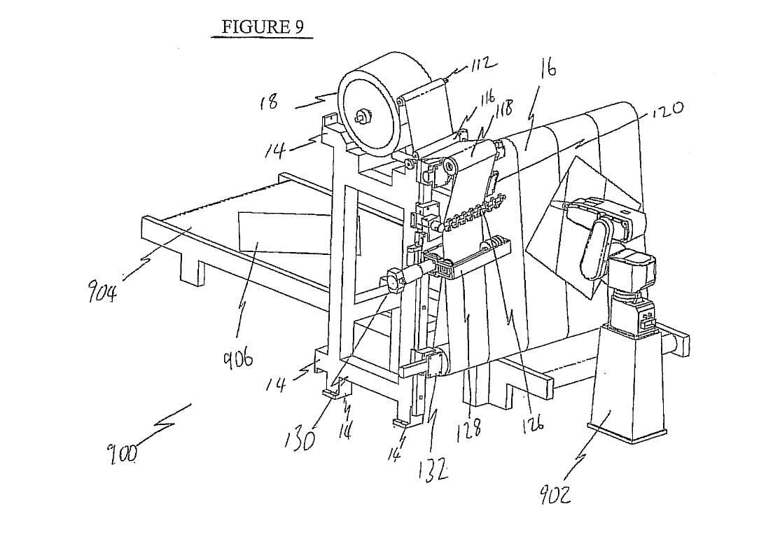

FIG. 9 illustrates further embodiment of the apparatus 900; a two mandrel 130, 132 machine with robot guided cutting laser 902, being an example of cutter 134 and on offload conveyor 904. Here cutter 134 has been programmed to cut tape 16 into sheets 906.

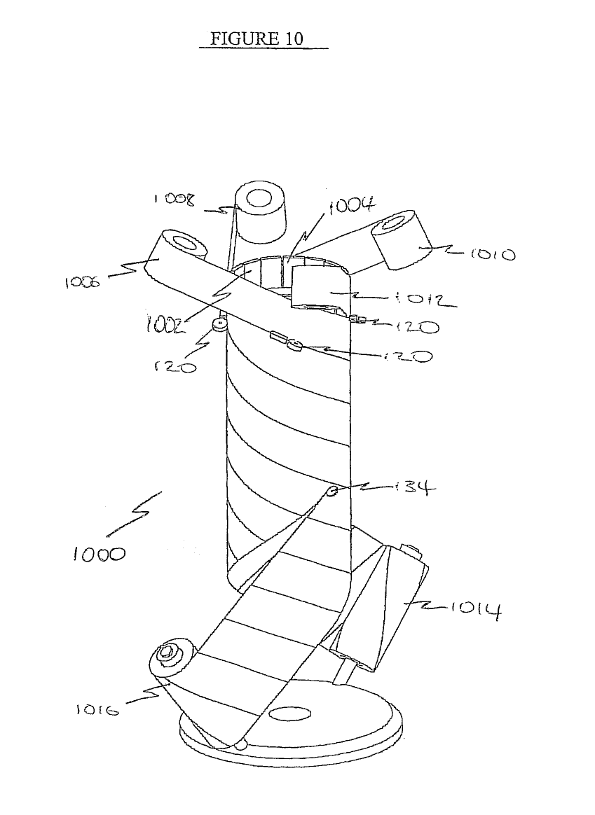

FIG. 10 illustrates part of a further embodiment 1000 of the invention. The embodiment features single mandrel 1002, 4 strips of infeed tape 1006, 1008, 1010,1012 and 2 converted strips of outfeed 1014, 1016 which here comprises a continuous tape product. Notably in this diagram, mandrel 1002 comprises a plurality of slats 1004. Note that the vertical orientation of mandrel 1002 is advantageous in that is the converted material may be subject to lower stress.

Heating means 120 and cutter 134 are present and are as described elsewhere in the description, having been adapted to function in the context of this embodiment in a manner known to the skilled man.

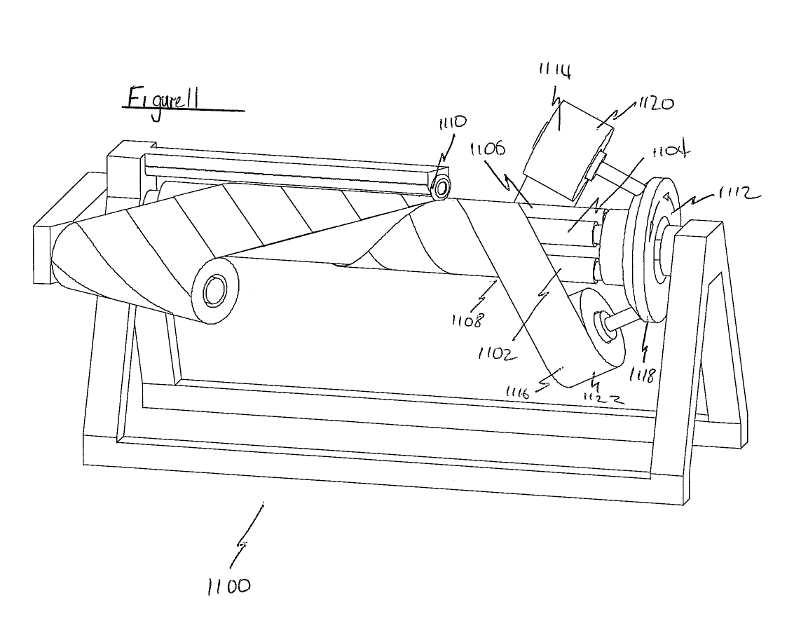

FIG. 11 shows a further embodiment of the invention 1100. This comprises 4 mandrels 1102, 1104, 1106, 1108 (not shown) and one cutter 1110 which is fixed. In use, upon actuation, the tube formation parts 1112, which in this embodiment carry the mandrels 1102, 1104, 1106, 1108 rotate as a body. Because the infeed material 1114, 1116 the drum assembly 1118 and the joining method (not shown) rotates and the drums 1120 1122 also rotate on their own axes, there is no need to supply a separately rotating collection system.

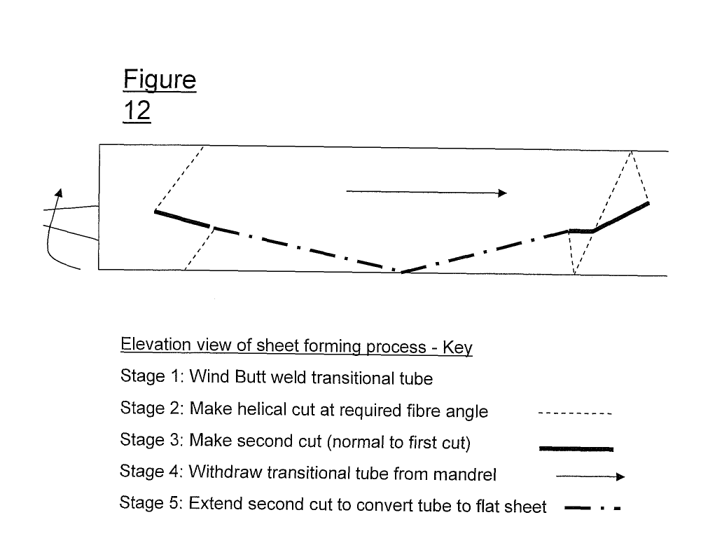

FIG. 12 illustrates the cutting of the cohesive transitional tube, which allows the separation of the required quantity of material from the advancing cohesive transitional tube, which is subsequently opened out to produce sheet material of specified width, length and fibre orientation. The various steps are represented in diagrammatic form by different line styles. The key to these line styles is presented with the diagram for ease of use.

The term “tape” is used herein to include all UD composite materials made using a thermoplastic or pseudo-thermoplastic resin as the impregnant, which may be joined to itself by methods known to the man skilled in the art. Examples of such resins include: PP, PA, PAI, PET, PEEK, PEI, PEKK, PI and PPS, although others may be used. The reinforcing fibres used in conjunction with these thermoplastic matrices may be any of the many known to the man skilled in the art. In particular those of bi-component or heterofil form may be appropriate. The impregnant used in the prepreg may be any suitable thermoplastic or pseudo-thermoplastic resin. Fibres used may for example be continuous UD fibres. Alternatively, they could be short, and could come from a range of 2 and 101 mm

The method and apparatus of the invention may be used to produce single ply, cross and angle ply thermoplastic prepregs including continuous prepregs, flat sheet materials and shaped materials, which may have any planar fibre orientation.

By “transitional tube”, the specification means the state of a tube is only a step in the process, before the cutting stage, which produces a tape or tapes and sheets.

By “off-axis manner”, it is meant “at an angle to the fibre axis”.

In some embodiments, a plurality of tapes will be used as the infeed. Equally, the transitional tube may be cut so as to produce a plurality of outfeed strips.

The following further comments on the stages of the process should be noted.

With regard to the joining of the edges of the tape 16, the edges are heated and brought into contact under pressure from consolidating rollers, followed by forced or natural cooling. The heat source may be any of the following: Infrared from a lamp or laser, contact with a hot shoe or roller, a hot air jet, ultrasonics or RF. Alternative methods to a heat source are further envisaged, including welding using a filler bead, bridging the joint using another continuous tape which might be joined by continuous or discontinuous means (weld, adhesive or staple), or overlapping the material to form a transitional tube wholly or partly double thickness.

A further key area is the control of the helical path of the transitional tube over the mandrel or mandrels. Since inaccuracies in guidance lead to variations in quality of the edge joint, and variations in flatness and internal stresses in the finish product it is important that control is strict. Methods of achieving accurate guidance include the use of driven nip rollers which are steered under servo control; the use of slatted mandrels where the axial movement of the slats in relation to rotation is controlled by swashplates; and driven rollers with passive axial movement of the slats under the influence of a non-driven, servo-steered friction roller.

The cutting of the transitional tube may vary depending on the type of output required: For continuous off-axis strip(s), unidirectional cutting is required. Where the output is to be in the form of rectangular or rhomboidal sheets, cutting in one direction can be as for continuous strip, and a second similar method can be used for the other axis, or parts of the transitional tube may be left unwelded where the second axis coincides with the incoming strip edge. This would be particularly cost effective for 0/90 deg sheets, where the sheet edges parallel to the fibre axis could be generated by temporarily inhibiting the weld process.

For directly cutting irregularly shaped laminates from the tube, an omnidirectional method of cutting should be used, such as laser, ultrasonic knife, abrasive jet or nibbler. Such methods provide maximum flexibility when directed by means such as a multi-axis robot, which can be programmed to make discontinuous, connected cuts, particularly useful where the transitional tube rotates.

The final stage is the collecting of the output off-axis material. A number of ways of collection are envisaged for the various products which may be produced by different embodiments of the invention.

Strip material may be coiled onto driven mandrel(s). In some embodiments, the collection means may rotate about the axis of the transitional tube. Alternatively the transitional tube, the joining equipment and the input guidance equipment may be rotated such that the cutter generating the slit edge is stationary. A further alternative is that the strip may be collected inside an open ended drum, a long mandrel, or on a conveyor.

Sheets or finish-shape laminates may be collected via gravity chute, conveyor, or mechanical handling device. This mechanical handling device could employ grippers or suction pads guided by a robot or other device.

The collection method will be an important factor in determining the orientation and rotation of the process. The off-axis material is relatively weak normal to the fibre axis, and stresses due to cutting, handling and gravity must be minimised.

An envisaged route for cutter 134 is as follows: Upon actuation, cutter 134 follows a path such that one axis follows a helical path defining the fibre orientation of the product whilst the second connects the start and finish of the first cut, so creating a complete peripheral cut and enabling the separation of the required quantity of material from the advancing cohesive transitional tube, which may subsequently be opened out into a UD, single ply sheet of specified width, length and fibre orientation.

1. An apparatus for producing one of a single ply, continuous ply, cross ply and an angle ply thermoplastic prepreg comprising:
means for feeding a tape of thermoplastic prepreg material into the apparatus and around at least one carrier;
means for positioning and aligning the tape to form a tube in such a way as to maintain substantially uninterrupted contact between the leading edge of the incoming tape of material and the receding edge of the previous wrap of the tape;
means for creating a cohesive transitional tube by joining the edges of adjacent wraps;
means for cutting the resulting cohesive transitional tube so as to produce at least one thermoplastic prepreg product with desired shape, size and ply fibre orientation; and
means for collecting the thermoplastic prepreg products so produced.

2. Apparatus according to claim 1, and in which the tape is fed around successive carriers capable of relative movement towards and/or away from one another.

3. An apparatus according to claim 1, wherein at least one carrier is slatted.

4. An apparatus according to claim 1, wherein at least one carrier has rotational and axial degrees of freedom of movement.

5. An apparatus according to claim 1, wherein the joining of the edges of the adjacent wraps of the cohesive transitional tube is effected within a planar section of the periphery of the tube.

6. An apparatus according to claim 1, wherein, upon actuation, the means for cutting the material moves with multiple degrees of freedom to define a path to cut the cohesive transitional tube into sections and profiles of the desired shape, size and fibre orientation.

7. An apparatus according to claim 1, wherein, upon actuation, the means for cutting the cohesive tube follows an helical path to produce at least one of continuous, unidirectional, single ply, cross and angle ply composite prepregs with the desired fibre orientation.

8. An apparatus according to claim 1, wherein the manner of cutting the resulting cohesive transitional tube is slitting.

9. A method, for producing at least one of unidirectional, single ply, continuous, cross ply or angle ply thermoplastic prepreg, comprising:
forming a tape of thermoplastic prepreg into a tube, by wrapping it around a system comprised of at least one carrier;
positioning and aligning the tape to form a tube in such a way as to maintain substantially uninterrupted contact between the leading edge of the incoming tape of material and the receding edge of the previous wrap of the tape;
creating of a cohesive transitional tube by joining the edges of adjacent wraps;
cutting of the resulting transitional tube, to produce the required thermoplastic prepreg product, and
collecting of the prepreg products so produced.

10. Products comprising thermoplastic prepregs in initially continuous form, whenever made by an apparatus or method claimed in claim 9.

11. (canceled)

12. An apparatus for producing one of a single ply, a continuous ply, a cross ply and an angle ply thermoplastic prepeg comprising:
a feeder for feeding a tape of thermoplastic prepeg material into the apparatus and around at least one carrier.
guides for positioning an aligning the tape to form a tube in such a way as to maintain substantially uninterrupted contact between the leading edge of the incoming tape of material and the receding edge of the previous wrap of the tape;
joining equipment for creating a cohesive transitional tube by joining the edges of adjacent wraps;
a cutter for cutting the resulting cohesive transitional tube so as to produce at least one thermoplastic prepeg product with desired shape, size and ply fibre orientation; and
a collector for collecting the thermoplastic prepeg products so produced.

13. The method according to claim 9, wherein the tape is fed around successive carriers capable of relative movement towards and/or away from one another.

14. The method according to claim 9, wherein the joining of the edges of the adjacent wraps of the cohesive transitional tube is effected within a planar section of the periphery of the tube.

15. The method according to claim 9, wherein, upon actuation, cutting the material moves with multiple degrees of freedom to define a path to cut the cohesive transitional tube into sections and profiles of a desired shape, size and fibre orientation.

16. The method according to claim 9, wherein, upon actuation, cutting the cohesive tube comprises following a helical path to produce the composite prepregs with a desired fibre orientation.

17. The method according to claim 9, wherein cutting the cohesive transitional tube comprises slitting.
